(19) United States
(12) Patent Application Publication
(10) Pub. No.: US 2009/0141320 A1
(43) Pub. Date: Jun. 4, 2009

(54) IMAGE PROCESSING APPARATUS AND IMAGE PROCESSING METHOD

(75) Inventor: Katsushi MINAMINO, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/269,964

(22) Filed: Nov. 13, 2008

(30) Foreign Application Priority Data
Dec. 3, 2007 (JP) 2007-312754

(51) Int. Cl. H04N 1/46; G06K 15/02

(52) U.S. Cl. 358/512; 358/1.2

(57) ABSTRACT

An image processing apparatus reads out image data stored in an image memory unit, performs size reduction, when the read out image data is color image data, on a plurality of pieces of color component data of the color image data by using different pixel number reducing circuits and different filter circuits, performs size reduction, when the read out image data is monochrome image data, on a plurality of pieces of monochrome image data by using the different pixel number reducing circuits and different filter circuits, and generates reduced-size images for a thumbnail display from the reduced-size image data.

### CROSS-REFERENCE TO RELATED APPLICATIONS

This application claims priority under 35 U.S.C. 119 to Japanese Patent Application No. 2007-312754, filed on Dec. 3, 2007, which application is hereby incorporated by reference in its entirety.

### BACKGROUND OF THE INVENTION

1. Field of the Invention

The present invention relates to an image processing apparatus and an image processing method arranged to generate a list of display images (referred to as “thumbnails”) by reducing a size of a plurality of pieces of image data in order to generate a plurality of reduced-size images, and then combining the reduced-size images.

2. Description of the Related Art

In scanner devices, color copiers, and a Multi Function Peripherals (MFPs), an image processing apparatus that includes a function of storing image data in a memory, reducing a size of stored image data, and displaying thumbnails on a display unit, such as a monitor, has been suggested.

When reducing a size of images, a method of thinning out a pixel for every prescribed one of a plurality of pixels in a main scanning direction from image data, or a method of thinning out one line of pixels for every prescribed one of a plurality of lines in a sub scanning direction from image data, is used. However, when performing size reduction by simply thinning out the pixels as described above, some image data is erroneously omitted, which thereby deteriorates a quality of the reduced-size images.

Accordingly, prescribed pixels are determined vertically and horizontally (for example, 7×7 pixels) as a range of the image data, and after smoothing the data by using a target pixel, which is the center of the range, and surrounding pixels centering on the target pixel, the size of the data is reduced in order to maintain the image quality.

When reducing a size of image data, a processing circuit arranged to perform size reduction is commonly used. Some image processing apparatuses include both a processing circuit used for color image data and a processing circuit used for monochrome image data, and some image processing apparatuses include only a processing circuit used for color image data. A problem with an image processing apparatus that includes both the processing circuit used for color image data and the processing circuit used for monochrome image data is that, even though processing speed is high, a cost is also increased.

An image processing apparatus that includes only the processing circuit used for color image data makes it possible to reduce the cost by reducing a size of monochrome image data by using the processing circuit used for color image data. The image processing apparatus of this type includes three processing circuits, each corresponding to the respective Red, Green, and Blue (RGB) components of color image data. When reducing the size of monochrome image data composed of bi-level data, one of the three processing circuits is used in order to reduce a size of a corresponding image.

However, when reducing the size of one piece of monochrome image data, the image processing apparatus that includes only the processing circuit used for color image data uses one of the three processing circuits. Accordingly, an amount of time required for reducing the size of the monochrome image data does not differ from an amount of time required for reducing the size of the color image data. In other words, even though an amount of data of the monochrome image is smaller than that of the color image, the size reduction for the monochrome image data requires substantially the same amount of time as the size reduction of a color image which thereby reduces the efficiency.

### SUMMARY OF THE INVENTION

In order to overcome the problems described above, preferred embodiments of the present invention provide an image processing apparatus and an image processing method that make it possible to reduce an amount of time that is required to reducing a size of a monochrome image without deteriorating a quality of image data.

A preferred embodiment of the present invention provides an image memory unit arranged to store a plurality of pieces of image data and a size-reducing process unit arranged to reduce a size of the plurality of pieces of image data read out from the image memory unit in order to generate images for thumbnail display. The size-reducing process unit includes a plurality of pixel number reducing circuits and a plurality of filter circuits each corresponding to the respective pixel number reducing circuits. The pixel number reducing circuits and the filter circuits are arranged to execute a size reduction in parallel. When generating a reduced-size image of a color image, each size of a plurality of color component data of color image data is reduced by using the respective pixel number reducing circuits and filter circuits. When generating a reduced-size image of a monochrome image, the respective pixel number reducing circuits and filter circuits are used with respect to a plurality of pieces of monochrome image data.

The image data indicates collections of pixel data in which a plurality of pieces of pixel data are two-dimensionally aligned. The filter circuit is arranged to add all values that are acquired by multiplying a target pixel by a coefficient and multiplying surrounding pixels centering on the target pixel by another coefficient, and then newly acquire a value of the target pixel by dividing the acquired value by a sum of the coefficients.

In the above-described configuration, when generating a reduced-size image for a thumbnail display of monochrome image data, a size of a plurality of pieces of monochrome image data can be reduced in parallel by using the plurality of pixel number reducing circuits and filter circuits. Accordingly, each size of the plurality of pieces of monochrome image data can be reduced within an amount of time that has been required for reducing a size of one piece of monochrome image data. Therefore, the amount of time for generating a thumbnail display image in which the reduced-size images are aligned based on the monochrome image data can be reduced.

According to a preferred embodiment of the present invention, the size-reducing process unit includes an image dividing module arranged to generate a plurality of pieces of divided monochrome image data each having a different position in a sub scanning direction by dividing one piece of monochrome image data having a plurality of consecutive lines such that the divided number of the monochrome image data will be equal to or less than the number of filter circuits. A size of each of the divided monochrome image data is reduced by using the respective pixel number reducing circuits and filter circuits.

When dividing one monochrome image file having two pieces of monochrome image data into a plurality of pieces of monochrome image data, for example, the two pieces of monochrome image data are divided by the three pixel number reducing circuits and the three filter circuits such that the first piece of monochrome image data is divided into two at a two-thirds area disposed from a leading end in the sub scanning direction, and the last piece of monochrome image data is divided into two at a one-third area disposed from a leading end. At this time, each of the one-third areas of the divided image data is combined, and the size of the combined data is reduced by one pixel number reducing circuit and one filter circuit. Moreover, each size of the two-thirds areas of the divided image data is separately reduced by the respective pixel number reducing circuits and filter circuits.

The monochrome image data is divided into three by one third such that each position in the sub scanning direction of the divided data differs from one another when processing one piece of monochrome image data by using the three pixel number reducing circuits and the three filter circuits and each size of the divided image data is reduced by the respective pixel number reducing circuits and filter circuits.

When generating reduced-size images for a thumbnail display of a plurality of pieces of monochrome image data, if there is an odd piece of monochrome image data, one piece of monochrome image data is divided by a prescribed area, and each size of the divided monochrome image data is reduced in parallel by the respective pixel number reducing circuits and filter circuits. As a result, the plurality of pixel number reducing circuits and filter circuits can be efficiently used in order to generate the reduced-size images for thumbnail display.

According to a preferred embodiment of the present invention, the image dividing module divides one piece of monochrome image data such that each of the divided monochrome image data includes an overlap area, reduces each size of the divided monochrome image data by using the pixel number reducing circuits after performing a filtering process on each of the divided monochrome image data by using the filter circuits, and combines the reduced-size, divided monochrome image data into one piece of monochrome image data.

The overlap area is provided between each of the divided monochrome image data, and the filtering process is also performed on the overlap area. Accordingly, distortion does not occur at the overlap area when each of the reduced-size, divided image data is combined. Furthermore, the combined monochrome image data is identical to data that is obtained by reducing a size of one piece of monochrome image data.

In addition to the above-described configuration, a preferred embodiment of the present invention preferably provides a grayscale conversion module that converts monochrome image data composed of bi-level image data into grayscale data.

For example, since the monochrome image data received via facsimile is bi-level image data, the size of the monochrome image data cannot be reduced by the plurality of pixel number reducing circuits and filter circuits used for color image data. Accordingly, by converting the bi-level data into grayscale data, even if the image data stored in the image memory unit is monochrome bi-level image data, a size of the monochrome bi-level image data can be reduced by using the plurality of pixel number reducing circuits and filter circuits.

According to a preferred embodiment of the present invention, because the size of the plurality of pieces of monochrome image data is reduced within an amount of time that is required for reducing a size of one piece of monochrome image data, the amount of time for generating thumbnail display images of the monochrome image data is reduced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a configuration of an MFP according to a preferred embodiment of the present invention.

FIG. 2 is a block diagram illustrating an example of a function for generating thumbnail display images in the MFP.

FIG. 3 illustrates states of image data when a size of color image data is reduced with respect to each RGB component data.

FIG. 4 illustrates states of image data when a size of monochrome image data is reduced page by page.

FIG. 5 is a block diagram illustrating another configuration of a size-reducing process unit of the MFP according to a second preferred embodiment of the present invention.

FIG. 6 illustrates image data of the time when two pages of monochrome image data is separately divided into two, and each size of the divided data is reduced.

FIG. 7 illustrates image data of the time when one page of monochrome image data is divided into three, and each size of the divided data is reduced.

### DETAILED DESCRIPTION OF PREFERRED EMBODIMENTS

### First Preferred Embodiment

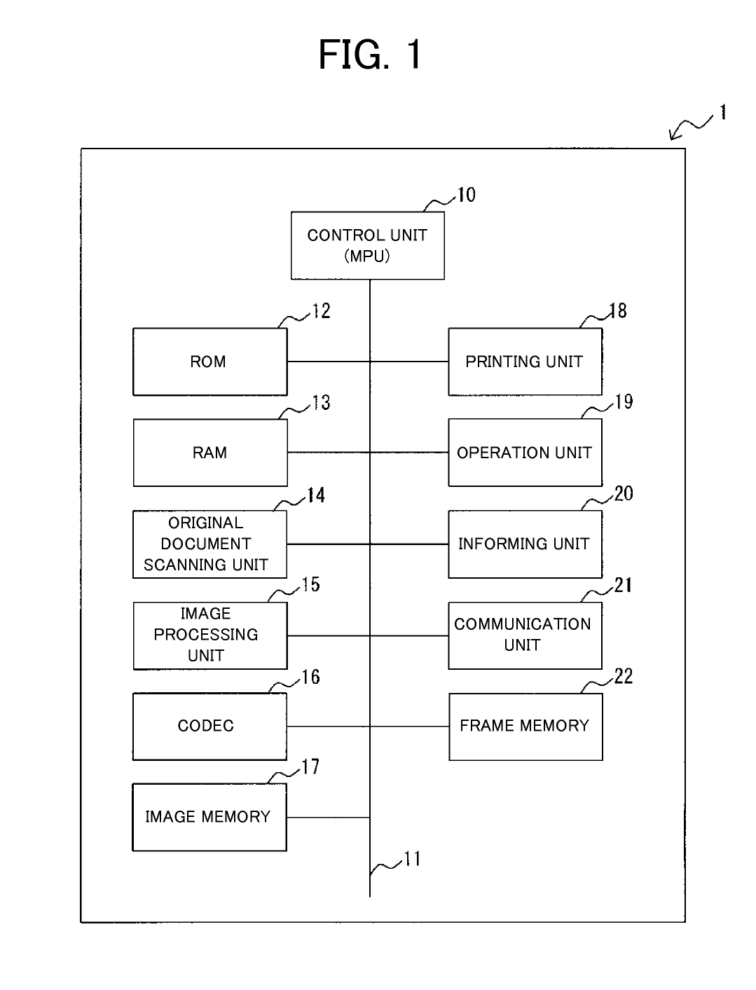

FIG. 1 is a block diagram illustrating a configuration of an image processing apparatus according to a preferred embodiment of the present invention, and illustrates an MFP 1 as an example of the image processing apparatus. The MFP 1 includes a control unit 10 having a Micro Processing Unit (MPU), a Read Only Memory (ROM) 12, a Random Access Memory (RAM) 13, an original document scanning unit 14, an image processing unit 15, a coder and decoder (CODEC) 16, an image memory 17, a printing unit 18, an operation unit 19, an informing unit 20, a communication unit 21, and a frame memory 22. The Rom 12, the RAM 13, the original document scanning unit 14, the image processing unit 15, the CODEC 16, the image memory 17, the printing unit 18, the operation unit 19, the informing unit 20, the communication unit 21, and the frame memory 22 are connected with the control unit 10 via a parallel bus 11.

In the MFP 1, one of a facsimile mode, a copy mode, a scanner mode, and a printer mode, for example, is selected, and processes are executed in accordance with the selected mode.

In the facsimile mode, scanned original document image data is transmitted to another facsimile machine. Moreover, an image is printed on a page based on facsimile image data (FAX image data) received from the other facsimile machine. The received FAX image data can be stored in the image memory 17. The FAX image data is monochrome bi-level image data, and received in a state in which the data is compressed by a Modified Huffman (MH) method, a Modified Read (MR) method, or a Modified MR (MMR) method. The compressed FAX image data is stored in the image memory 17.

In the copy mode, an image is printed on a page based on scanned original document image data. In the printer mode, an image can be printed on a page based on a Page Description Language (PDL) received from a terminal device connected via a network. The PDL received from the terminal device can also be stored in the image memory 17. The image data generated from the PDL is either color image data or monochrome image data.

The color image data may be color image data (hereinafter, referred to as RGB color image data) that is generated with pixel data composed of intensity data with respect to each RGB color component or image data (Joint Photographic Experts Group (JPEG) image data) that is compressed through a JPEG method. The monochrome image data may be monochrome bi-level image data (including black and white data, and also homochromatic data), grayscale image data that is generated with pixel data composed of gray component intensity data, or JPEG image data.

In the scanner mode, scanned original document image data is transmitted to the terminal device connected via the network, or scanned image data is stored in the image memory 17. The image data scanned in the scanner mode is one of RGB color image data, color or monochrome JPEG image data, and monochrome bi-level image data.

Computer programs executed by the control unit 10 are stored in the ROM 12. Necessary data is stored in the RAM 13 based on the program execution performed by using the control unit 10. The original document scanning unit 14 irradiates an original document with light, receives the reflected light from the original document by using a photoelectric transducer, for example, and outputs signals in accordance with an amount of the received light.

Based on the signals output from the original document scanning unit 14, the image processing unit 15 processes the image signals in order to generate image data, outputs the image data to the CODEC 16 in order to perform a compression process, or directly stores the image data in the image memory 17. Further, the image processing unit 15 reduces a size of a plurality of pieces of image data stored in the image memory 17 in order to generate reduced-size images for thumbnail display, and generate thumbnail images in which these reduced-size images are aligned.

The CODEC 16 compresses the image data that is input from the image processing unit 15, stores the compressed image data in the image memory 17, and reads out the compressed image data from the image memory 17 in order to expand the data.

The printing unit 18 includes, for example, a commonly-known configuration having a photoconductive drum, a main charger, a developer, a transfer unit, and a fuser, or the like, and prints images on a page based on image data. For example, in the copy mode, the printing unit 18 prints the images on the page based on the original document image data scanned by the original document scanning unit 14.

The operation unit 19 includes a plurality of keys for user operations, and can perform various setting operations in addition to the above-described mode selecting operation. The informing unit 20 is provided to inform a user of prescribed information, and informs the user of various pieces of information using a display unit, such as a Liquid Crystal Display (LCD), and a loud speaker, or the like.

The communication unit 21 is connected with another facsimile machine via a Public Switched Telephone Network (PSTN, not illustrated) such as a telephone line, and with another terminal device via a Local Area Network (LAN, not illustrated). Although not illustrated, the communication unit 21 includes an interface connected to the PSTN, and an interface connected to the LAN.

When transmitting a facsimile, after the connection with the destination facsimile machine is established via the PSTN through the communication unit 21, the original document image data scanned by the original document scanning unit 14 is transmitted to the destination facsimile machine. When receiving facsimile, the FAX image data is received from the destination facsimile machine via the PSTN by the communication unit 21, and the received data is stored in the image memory 17. The FAX data stored in the image memory 17 is read out from the image memory 17, and expanded by the CODEC 16. The image based on the expanded image data is printed on the page by the printing unit 18.

When transmitting/receiving the image data via the LAN, the communication unit 21 controls, by using the interface, signals input to and output from the LAN. For example, in the scanner mode, the original document image data scanned by the original document scanning unit 14 is transmitted to the other terminal device connected with the LAN via the interface. In the printer mode, based on the PDL received via the interface from the other terminal device connected to the LAN, the image is printed on the paper by the printing unit 18.

The frame memory 22 is arranged to store the thumbnail images in which the plurality of reduced-size images generated by the image processing unit 15 are aligned. The thumbnail images stored in the frame memory 22 are displayed on a display unit 20a of the informing unit 20.

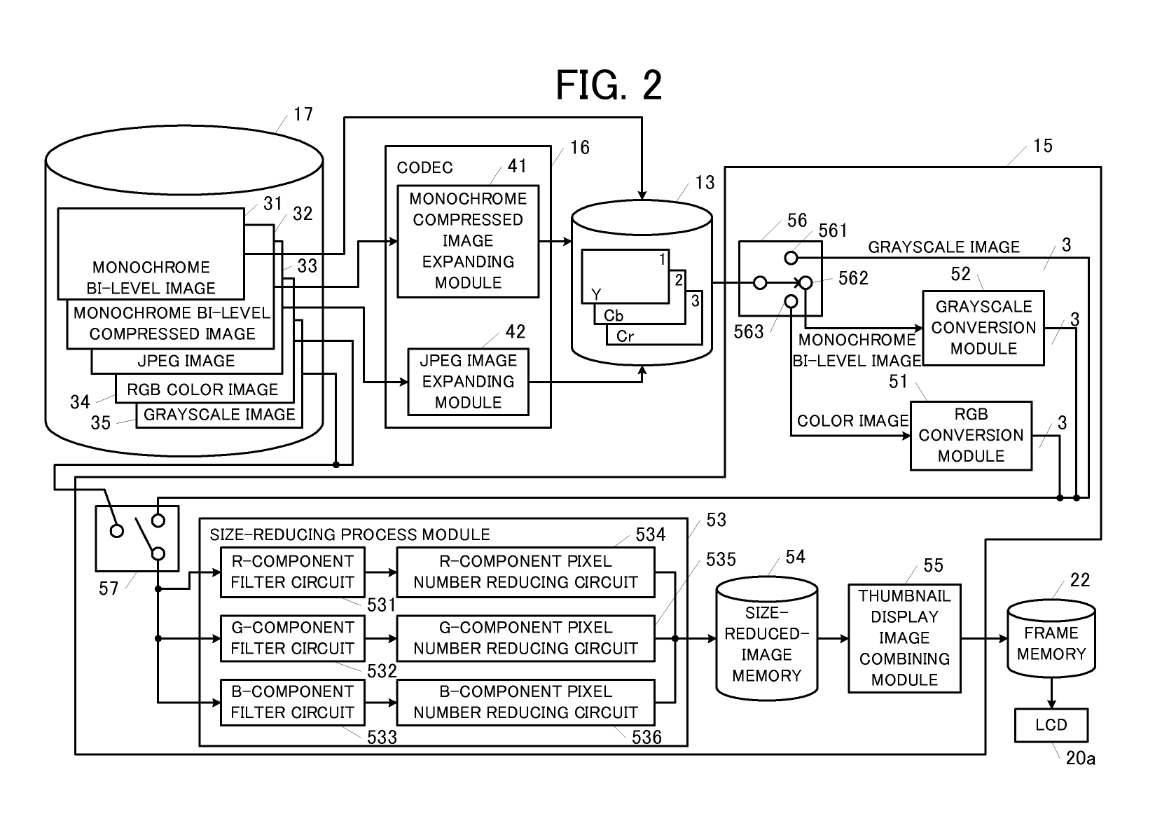

FIG. 2 is a functional block diagram illustrating a preferred embodiment of a configuration arranged to generate the thumbnail images in the MFP 1. In the MFP 1, the thumbnail images are generated by using the plurality of pieces of image data stored in the image memory 17.

The following folders are created in the image memory 17:

(1) a monochrome image folder 31 in which uncompressed monochrome bi-level image data is stored;
(2) a monochrome bi-level compressed image folder 32 in which monochrome bi-level compressed image data, such as the FAX image data, is stored;
(3) a JPEG image folder 33 in which color or grayscale JPEG image data is stored;
(4) an RGB color image folder 34 in which RGB color image data is stored; and
(5) a grayscale image folder 35 in which grayscale image data is stored.

The CODEC 16 includes a monochrome-compressed-image expanding module 41 and a JPEG image expanding module 42. The monochrome-compressed-image expanding module 41 expands the monochrome bi-level compressed image data stored in the monochrome bi-level compressed image folder 32 of the image memory 17, such as the FAX image data, in a compressed state. The monochrome-compressed-image expanding module 41 also decodes the monochrome bi-level image data compressed by the MH method, the MR method, or the MMR method.

The JPEG image expanding module 42 expands the JPEG image data stored in the JPEG image folder 33 of the image memory 17. When expanding the JPEG image data, the JPEG image expanding module 42 performs a process of decoding the data with respect to each block, and a process of combining the plurality of decoded blocks. Accordingly, the blocks are combined, and thus, the expanded image data can be acquired. Then, the expanded monochrome bi-level image data or color image data is stored in the RAM 13.

The uncompressed monochrome bi-level image data stored in the monochrome image folder 31, and the monochrome bi-level image data, grayscale image data, color image data, which are expanded by the CODEC 16, are stored in the RAM 13 as YCbCr data composed of a luminance component (Y component) and color difference components (Cb and Cr).

The following methods can be used in order to write the color image data in the RAM 13.

(1) Pixels are sequentially written in the RAM 13 pixel by pixel with respect to each YCbCr component.
(2) The YCbCr components are written in the RAM 13 page by page.
(3) The YCbCr components are written in the RAM 13 line by line.

The image processing unit 15 includes an RGB conversion module 51, a grayscale conversion module 52, a size-reducing process module 53, a reduced-size image memory 54, a thumbnail display image combining module 55, a first switch 56, and a second switch 57. The RGB conversion module 51 converts the YCbCr color image data stored in the RAM 13 into pixel data that is composed of intensity data with respect to each RGB color component. The grayscale conversion module 52 converts the YCbCr grayscale image data stored in the RAM 13 into grayscale pixel data based on the luminance (Y) component.

The size-reducing process module 53 includes an R-component filter circuit 531, a G-component filter circuit 532, and a B-component filter circuit 533, which perform a filtering process for smoothing the data. The size-reducing process module 53 includes, in association with each filter circuit, an R-component pixel number reducing circuit 534, a G-component pixel number reducing circuit 535, and a B-component pixel number reducing circuit 536, all of which reduce the size of each image data on which the filtering process has been performed. The filter circuits and the pixel number reducing circuits perform different processes when generating the reduced-size images for thumbnail display of the RGB color image data and when generating the reduced-size images for thumbnail display of the grayscale image data.

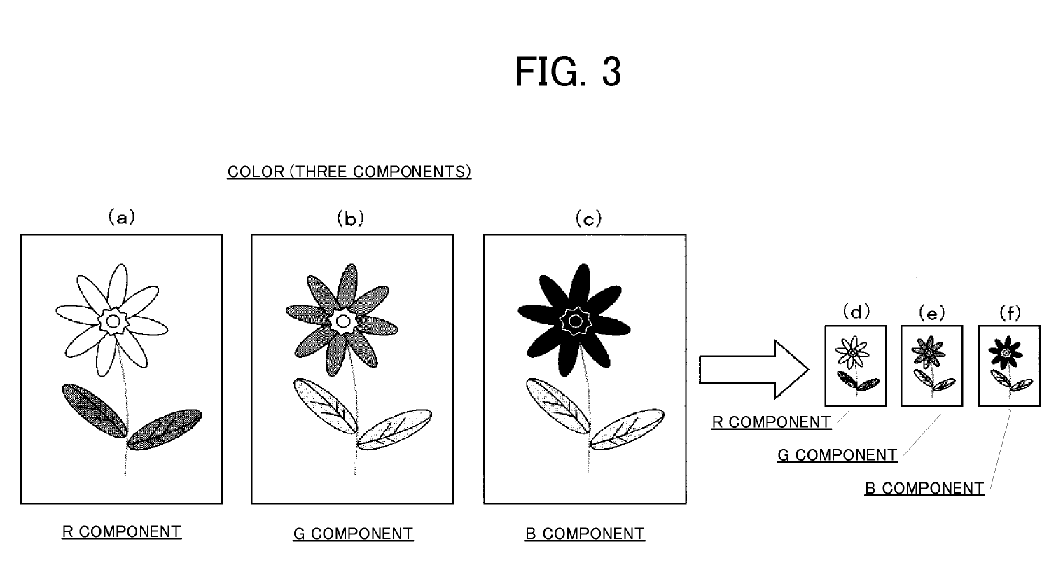

With reference to FIG. 3, a process of generating the reduced-size images for thumbnail display of the RGB color image data by the size-reducing process module 53 will be described. In the R-component filter circuit 531 and the R-component pixel number reducing circuit 534, after a filtering process is performed on R-component data (a) of one RGB color image data, a size of the R-component data is reduced in order to generate a reduced-size image (d) of the R-component data.

In the G-component filter circuit 532 and the G-component pixel number reducing circuit 535, after a filtering process is performed on G-component data (b) of the RGB color image data, a size of the G-component data is reduced in order to generate a reduced-size image (e) of the G-component data.

In the B-component filter circuit 533 and the B-component pixel number reducing circuit 536, after a filtering process is performed on B-component data (c) of the RGB color image data, a size of the B-component data is reduced in order to generate a reduced-size image (f) of the B-component data.

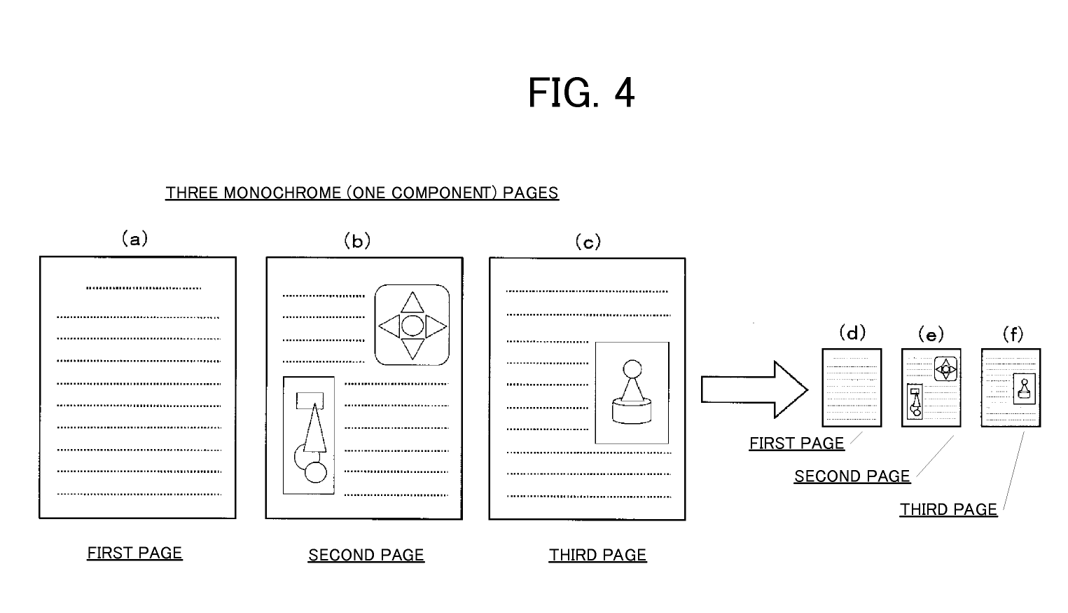

Next, with reference to FIG. 4, a process of generating the reduced-size images for thumbnail display of the grayscale image data by the size-reducing process module 53 will be described. In the R-component filter circuit 531 and the R-component pixel number reducing circuit 534, after a filtering process is performed on grayscale image data (a) of a first page (a first frame), a size of the grayscale image data is reduced in order to generate a first monochrome reduced-size image (d).

In the G-component filter circuit 532 and the G-component pixel number reducing circuit 535, after a filtering process is performed on grayscale image data (b) of a second page (a second frame) that is output from the RAM 13 following the grayscale image data processed by the R-component filter circuit 531 and the R-component pixel number reducing circuit 534, a size of the grayscale image data is reduced in order to generate a second monochrome reduced-size image (e).

In the B-component filter circuit 533 and the B-component pixel number reducing circuit 536, after a filtering process is performed on grayscale image data (c) of a third page (a third frame) that is output from the RAM 13 following the grayscale image data (b) processed by the G-component filter circuit 532 and the G-component pixel number reducing circuit 535, a size of the grayscale image data is reduced in order to generate a third monochrome reduced-size image (f). The size reduction performed by each filter circuit and pixel number reducing circuit is executed in parallel.

The filtering process and the size-reduction process are performed after the RGB conversion or grayscale conversion is performed on each image data, however, the filtering process and the size-reduction process may be performed before the RGB conversion or the grayscale conversion, and then, the RGB conversion or the grayscale conversion may be performed.

The reduced-size images reduced by the size-reducing process module 53 are sequentially stored in the reduced-size-image memory 54. Then, when the number of reduced-size images to be displayed as thumbnails in one frame is stored in the reduced-size-image memory 54, the reduced-size images are combined by the thumbnail image combining module 55 in order for the plurality of reduced-size images to be displayed as thumbnails in one frame.

When storing the reduced-size images for thumbnail display of the RGB color image data in the reduced-size-image memory 54, each component data generated by the respective pixel number reducing circuits is combined in order to generate a color reduced-size image. When storing the reduced-size images of the grayscale image data in the reduced-size-image memory 54, the first monochrome reduced-size images reduced by the R-component pixel number reducing circuit 534, the second monochrome reduced-size images reduced by the G-component pixel number reducing circuit 535, and the third monochrome reduced-size images reduced by the B-component pixel number reducing circuit 536, are sequentially stored.

Then, the thumbnail image combining module 55 combines the plurality of reduced-size images, which are generated by the size-reducing process module 53 and then stored in the reduced-size-image memory 54, in a prescribed order so as to display as thumbnails, and generates a thumbnail display image.

The thumbnail display image generated by the thumbnail display image combining module 55, i.e., for example, the thumbnail display image composed of the reduced-size images of the color image data, or the thumbnail display image composed of the reduced-size images of the monochrome image data, is stored in the frame memory 22. Then, the thumbnail display image is read out from the frame memory 22 and displayed on the display unit 20a composed of, for example, an LCD. The thumbnail display image may be a thumbnail image composed of the reduced-size images of the color image data and the reduced-size images of the monochrome image data.

The first switch 56 can be switched to any one of a first input 561 that sends out the grayscale image data, a second input 562 that sends out the monochrome bi-level image data, and a third input 563 that sends out the color image data, in accordance with a type of the image data that is output from the RAM 13.

The second switch 57 is arranged to switch whether to output, to the size-reducing process module 53, the image data stored in the RGB color image folder 34 or the image data stored in the grayscale image folder 35 of the image memory 17 or to output, to the size-reducing process module 53, the image data output from the RAM 13.

Moreover, 24-bit data is sent out from the first input 561 to the second switch 57, 3-bit data is sent out from the second input 562 to the grayscale conversion module 52, and 24-bit data is sent out from the third input 563 to the RGB conversion module 51. The 24-bit data is sent out from the RGB conversion module 51 or the grayscale conversion module 52 to the second switch 57, and 8-bit data is sent out from the second switch 57 to each filter circuit of the size-reducing process module 53.

When the first input 561 of the first switch 56 is turned to be in an input state, and the second switch 57 is turned to be in an input state in which the image data from the RAM 13 is input into the size-reducing process module 53, the grayscale image data is output from the RAM 13 to the first input 561, and then output to any one of the filter circuits of the size-reducing process module 53.

When the second input 562 of the first switch 56 is turned to be in an input state, and the second switch 57 is turned to be in an input state in which the image data from the RAM 13 is input into the size-reducing process module 53, the monochrome bi-level image data is sent out from the RAM 13 to the second input 562. Then, after the monochrome bi-level image data is converted into the grayscale image data by the grayscale conversion module 52, the grayscale image data is output to any one of the filter circuits of the size-reducing process module 53.

When the third input 563 of the first switch 56 is turned to be in an input state, and the second switch 57 is turned to be in an input state in which the image data from the RAM 13 is input into the size-reducing process module 53, the color JPEG image data is output from the RAM 13 to the third input 563. Then, after the color JPEG image data is converted into the RGB color image data by the RGB conversion module 51, the converted data is output to the size-reducing process module 53.

When turning the second switch 57 into an input state in which the image data is input from the image memory 17 to the size-reducing process module 53, regardless of the state of the first switch 56, the RGB color image data or the grayscale image data in the image memory 17 is output to the size-reducing process module 53.

When generating the thumbnail display image of the reduced-size images of the monochrome image data, the reduced-size images for thumbnail display are generated based on the monochrome image data in one frame by using one of the filter circuits and one of the pixel number reducing circuits of RGB components. Accordingly, three reduced-size images for monochrome thumbnail display can be generated in parallel by the three filter circuits and the three pixel number reducing circuits. When generating the thumbnail display image of the monochrome image data, the reduced-size images for thumbnail display can be generated in one third of the time required for generating the thumbnail display image of the color image data.

### Second Preferred Embodiment

In the above-described preferred embodiment, when the total number of monochrome image data for which the reduced-size images are generated for thumbnail display is not equal to an integral multiple of three, it is necessary to reduce the size of only the last piece of monochrome image data by using the R-component filter circuit 531 and the R-component pixel number reducing circuit 534, or it is necessary to reduce each size of the last two pieces of image data by using the R-component filter circuit 531, the R-component pixel number reducing circuit 534, the G-component filter circuit 532, and the G-component pixel number reducing circuit 535. In these cases, some filter circuit(s) and pixel number reducing circuit(s) are not used.

When reducing the size of the last piece of monochrome data or the last two pieces of monochrome data, all of the three filter circuits and the three pixel number reducing circuits are used so as to perform the size reduction process efficiently. In other words, one piece of monochrome image data is divided into two or three pieces of monochrome image data, and the size reduction for each of the divided data is executed by using the three filter circuits and the three pixel number reducing circuits.

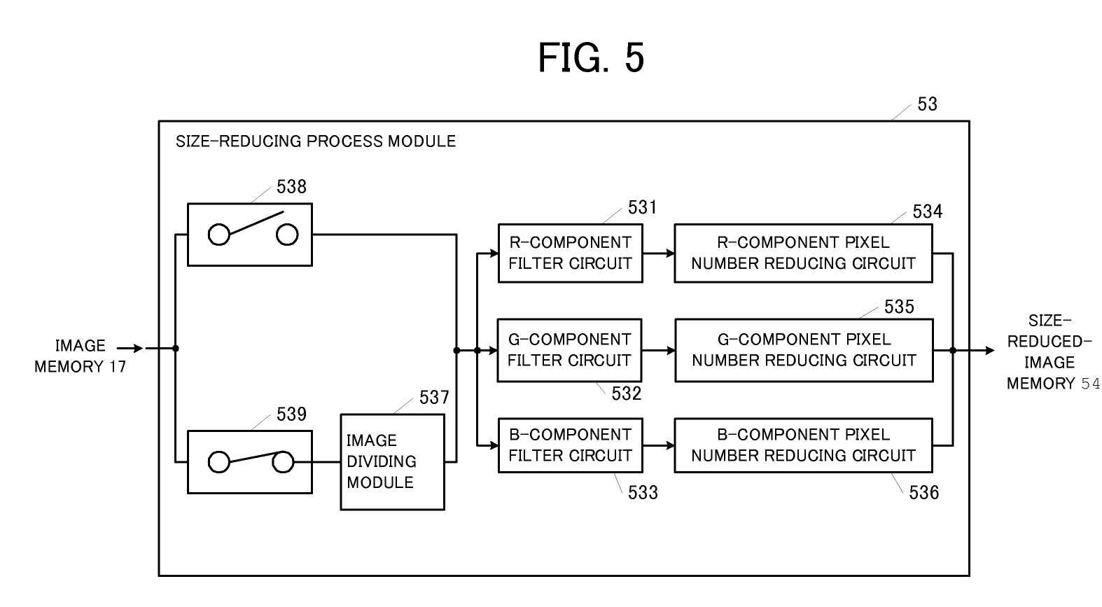

In the present preferred embodiment, the size-reducing process module 53 is configured as illustrated in the block diagram of FIG. 5. That is, the size-reducing process module 53 includes not only the R-component filter circuit 531, the R-component pixel number reducing circuit 534, the G-component filter circuit 532, the G-component pixel number reducing circuit 535, the B-component filter circuit 533, and the B-component pixel number reducing circuit 536, but also an image dividing module 537, a third switch 538, and a fourth switch 539. The third switch 538 and the fourth switch 539 are arranged in parallel before the R-component filter circuit 531, the G-component filter circuit 532, and the B-component filter circuit 533, and the image dividing module 537 is arranged between the fourth switch 539 and each filter circuit.

By closing the third switch 538 and opening the fourth switch 539, one piece of monochrome image data is sent to any one of the three filter circuits. By opening the third switch 538 and closing the fourth switch 539, one piece of monochrome image data is sent to the image dividing module 537, divided into two or three, and then the divided image data is sent to any one of the three filter circuits.

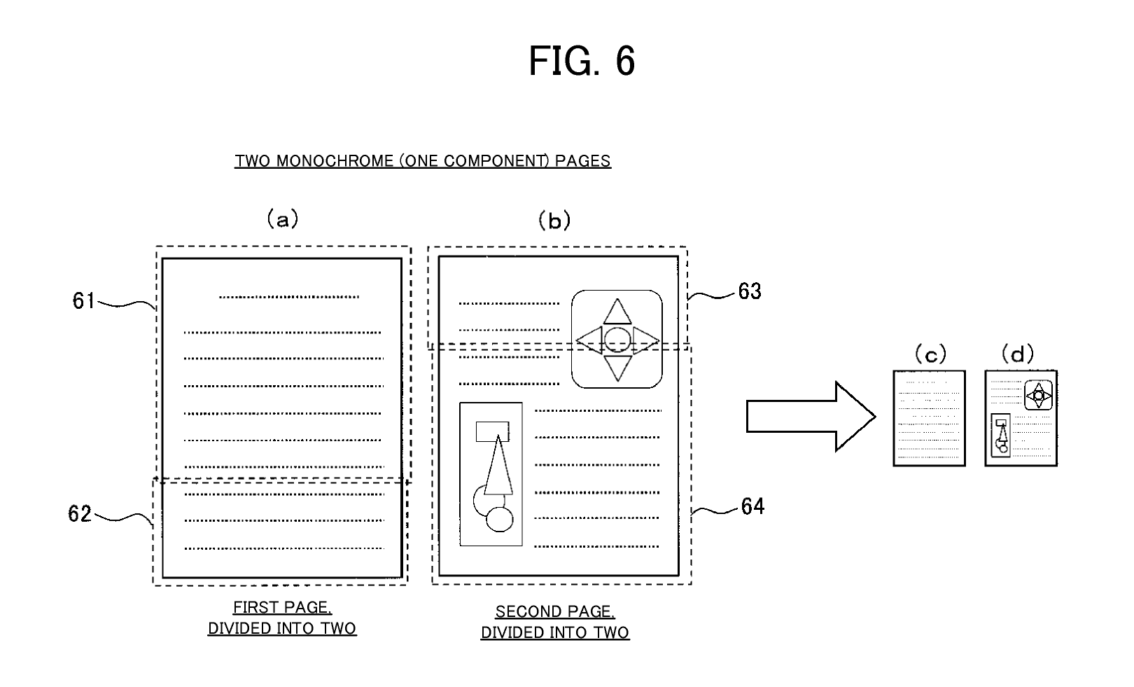

The image dividing module 537 can divide one piece of monochrome image data into two or three sections. For example, when the total page number of the monochrome image data for which the reduced-size images are generated for thumbnail display is not equal to the integral multiple of three, and when reducing the size of the last two pages of the monochrome image data as illustrated in FIG. 6, the first page (a) of the monochrome image data is divided into two sections, i.e., into a first divided image data 61, which corresponds to a two-thirds area in a sub scanning direction from the top of the page, and a second divided image data 62, which corresponds to a one-third area positioned below the above-described two-thirds area. The second page (b) of the monochrome image data is divided into two sections, i.e., into a third divided image data 63, which corresponds to a one-third area in the sub scanning direction from the top, and a fourth divided image data 64, which corresponds to a two-thirds area positioned below the above-described one-third area.

The size of the first divided image data 61 is reduced by the R-component filter circuit 531 and the R-component pixel number reducing circuit 534, each size of the second divided image data 62 and the third divided image data 63 is reduced by the G-component filter circuit 532 and the G-component pixel number reducing circuit 535, and the size of the fourth divided image data 64 is reduced by the B-component filter circuit 533 and the B-component pixel number reducing circuit 536.

When performing the size reduction by the G-component filter circuit 532 and the G-component pixel number reducing circuit 535, the size of the second divided image data 62 is reduced first, and then the size of the third divided image data 63 is reduced. After each size of the areas 61 through 64 is reduced, each of the reduced-size divided image data is combined to be the original two pages (c) and (d).

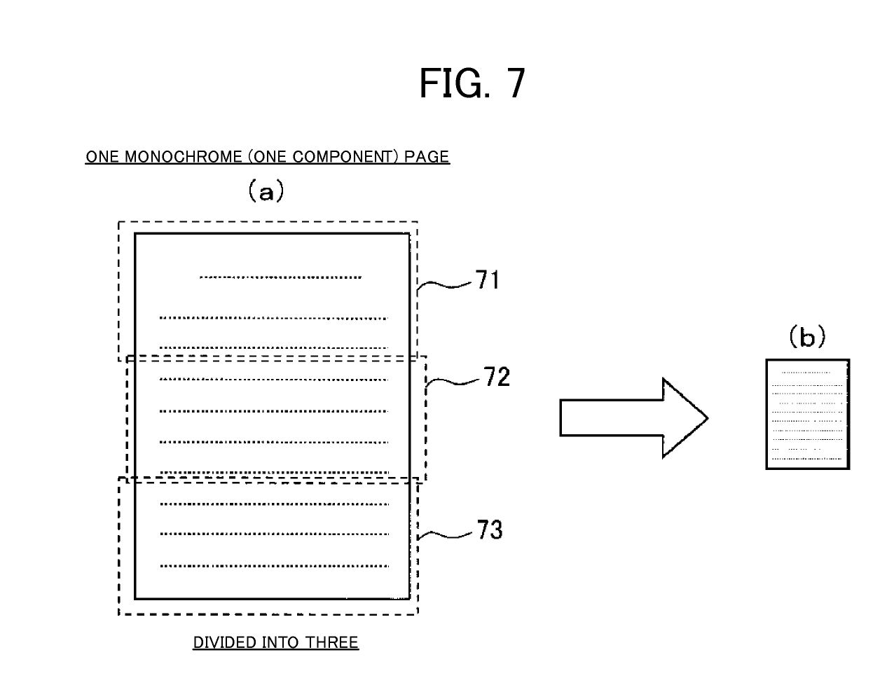

When reducing the size of only the last page of the monochrome image data, as illustrated in FIG. 7, one piece of monochrome image data (a) is divided equally into three sections, i.e., into a first divided image data 71, a second divided image data 72, and a third divided image data 73 in the sub scanning direction from the top.

Then, the size of the first divided image data 71 is reduced by the R-component filter circuit 531 and the R-component pixel number reducing circuit 534, the size of the second divided image data 72 is reduced by the G-component filter circuit 532 and the G-component pixel number reducing circuit 535, and the size of the third divided image data 73 is reduced by the B-component filter circuit 533 and the B-component pixel number reducing circuit 536.

After each size of the divided image data is reduced, each of the reduced-size divided image data is combined to be the original one page (b). When the data is divided into two or three sections, the monochrome reduced-size images combined into one page is stored in the reduced-size-image memory 54, and then combined with the monochrome reduced-size images that have been generated in the thumbnail display image combining module 55.

When dividing the monochrome image data, as indicated by dashed lines of FIGS. 6 and 7, each of the divided image data has an overlap area at each connected portion where each of the divided image data is connected with one another in the image dividing module 537.

For example, when one piece of monochrome image data having 1000 lines in one page is divided into two sections, and the image data is processed with a filter of 7×7 pixels, a range of an upper portion of the divided image data is set to be a range from the 1st line to the 503rd line, and a range of a lower portion of the divided image data is set to be a range from the 498th line to the 1000th line. In this case, the range from the 498th line to the 503rd line corresponds to the overlap area. The filtering process is performed on the pixels positioned on the 1st line through the 500th line for the upper portion of the divided image data, and the filtering process is performed on the pixels positioned on the 501st line through the 1000th line for the lower portion of the divided image data. For example, assuming that a pixel on the 500th line is determined to be a target pixel, when performing the filtering process, the filter circuits perform its process on the 49 pixels positioned on the 498th line through the 503rd line.

In the above-described process, when the total number of the monochrome image data for which the thumbnail display images thereof are generated is not equal to the integral multiple of three, the odd piece of monochrome image data is divided, and the three filter circuits and the three pixel number reducing circuits are efficiently used. Accordingly, the amount of time required to generate the reduced-size images for thumbnail display can be reduced.

Moreover, since each of the divided image data forms the overlap area at the connected portion, and the filtering process is performed on the data including the overlap areas, image distortion does not occur at the connected portion when each of the monochrome, reduced-size divided image data is combined. Further, the monochrome, combined image data becomes identical to the data obtained when the size-reducing process is performed on one piece of monochrome image data.

In the above-described preferred embodiment, the monochrome image data composed of the bi-level data is converted into grayscale data, however, the size-reduction process may be performed on homochrome image data after the homochrome image data is converted into multivalued data. Further, the thumbnail display of the reduced-size images may be performed in the image processing apparatus or in an external Personal Computer (PC).

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
an image memory unit arranged to store a plurality of pieces of image data; and
a size-reducing process module arranged to reduce a size of each of the plurality of pieces of image data read out from the image memory unit and to generate reduced-size images for thumbnail display; wherein
the size-reducing process module includes a plurality of pixel number reducing circuits and a plurality of filter circuits each corresponding to the respective pixel number reducing circuits, the pixel number reducing circuits and the filter circuits are arranged to perform the size reduction in parallel;
when generating a reduced-size image of a color image, the size-reducing process module performs a size reducing process on a plurality of pieces of color component data of the color image data by using the respective pixel number reducing circuits and filter circuits; and
when generating a reduced-size image of monochrome image data, the size-reducing process module performs the size reduction on a plurality of pieces monochrome image data by using the respective pixel number reducing circuits and filter circuits.

2. The image processing apparatus according to claim 1, wherein the size-reducing process module includes an image dividing module arranged to generate a plurality of pieces of divided monochrome image data each having a different position in a sub scanning direction by dividing one piece of monochrome image data having a plurality of consecutive lines such that the divided number of the data will be equal to or less than the number of filter circuits, and the size reduction is performed on each of the divided monochrome image data by using the respective pixel number reducing circuits and filter circuits.

3. The image processing apparatus according to claim 2, wherein the image dividing module divides one piece of monochrome image data such that each of the divided monochrome image data have an overlap area, and the size-reducing process module performs the size reduction by using the pixel number reducing circuits after performing a filtering process on each of the divided monochrome image data including the overlap area by using the filter circuits, and combines the reduced-size divided monochrome image data into one piece of monochrome image data.

4. The image processing apparatus according to claim 1, further comprising a grayscale conversion module arranged to convert monochrome bi-level image data into grayscale image data.

5. The image processing apparatus according to claim 4, further comprising a monochrome compressed image expanding module arranged to expand monochrome bi-level compressed image data read out from the image memory unit.

6. The image processing apparatus according to claim 1, further comprising a Red, Green, and Blue conversion module arranged to convert YCbCr color image data into Red, Green, and Blue color image data.

7. The image processing apparatus according to claim 6, further comprising a Joint Photographic Experts Group image data expanding module arranged to expand compressed Joint Photographic Experts Group color image data read out from the image memory unit into YCbCr color image data.

8. An image processing apparatus comprising:
a storing device arranged to store a plurality of pieces of image data;
a reducing device arranged to reduce each size of the stored plurality of pieces of image data and generating reduced-size images for thumbnail display;
a plurality of size reduction devices arranged to perform the size reduction in parallel;
a plurality of filtering devices arranged to perform a filtering process on the reduced-size image data;
a size reducing device arranged to perform a size reducing process and a filtering process on a plurality of pieces of color component data of color image data when generating a reduced-size image of a color image; and
a generation device arranged to perform a size reducing process and a filtering process on a plurality of pieces of monochrome image data when generating a reduced-size image of monochrome image data.

9. The image processing apparatus according to claim 8, further comprising:
a dividing device arranged to generate a plurality of pieces of divided monochrome image data each having a different position in a sub scanning direction by dividing one piece of monochrome image data having a plurality of consecutive lines; wherein
the size reduction is performed on each of the divided monochrome image data by using different devices arranged to perform the size reduction in parallel and by using a plurality of devices arranged to perform a filtering process on the reduced-size image data.

10. The image processing apparatus according to claim 9, further comprising:
an overlap device arranged to generate an overlap area for each of the divided monochrome image data; and
a combining device arranged to combine each of the reduced-size divided monochrome image data from which the overlap area is excluded into one piece of monochrome image data.

11. The image processing apparatus according to claim 8, further comprising a conversion device arranged to convert monochrome bi-level image data into grayscale image data.

12. The image processing apparatus according to claim 11, further comprising an expanding device arranged to expand monochrome bi-level compressed image data.

13. The image processing apparatus according to claim 8, further comprising a YCbCr conversion device arranged to convert YCbCr color image data into Red, Green, and Blue color image data.

14. The image processing apparatus according to claim 13, further comprising an expanding device arranged to expand compressed Joint Photographic Experts Group color image data into YCbCr color image data.

15. An image processing method comprising the steps of:
reading out image data stored in an image memory unit;
performing size reduction on a plurality of pieces of color component data of the color image data by using different pixel number reducing circuits and different filter circuits when the read out image data is color image data;
performing size reduction on a plurality of pieces of monochrome image data by using the different pixel number reducing circuits and different filter circuits when the read out image data is monochrome image data; and
generating a reduced-size image for a thumbnail display from the reduced-size image data.

16. The image processing method according to claim 15, further comprising a step of generating a plurality of pieces of divided monochrome image data each having a different position in a sub scanning direction by dividing one piece of monochrome image data having a plurality of consecutive lines such that the divided number of the data will be equal to or less than the number of filter circuits.

17. The image processing method according to claim 16, further comprising the step of:
dividing one piece of monochrome image data such that each of the divided monochrome image data has an overlap area; wherein
after a filtering process is performed on each of the divided monochrome image data including the overlap area by using the filter circuits, the size reduction is performed by the pixel number reducing circuits, and each of the reduced-size divided monochrome image data is combined into one piece of monochrome image data.

18. The image processing method according to claim 15, further comprising the step of converting monochrome bi-level image data into grayscale image data.

19. The image processing method according to claim 18, further comprising the step of expanding the read out monochrome bi-level compressed image data.

20. The image processing method according to claim 15, further comprising the step of converting the read out YCbCr color image data into Red, Green, and Blue color image data.
